(19) United States
(12) Patent Application Publication
(10) Pub. No.: US 2011/0298593 A1
(43) Pub. Date: Dec. 8, 2011

(54) ELECTRONIC DEVICE AND METHOD FOR CONTROLLING THE SAME

(75) Inventor: Makoto Sugiyama, Singapore (SG)

(73) Assignee: TOSHIBA TEC KABUSHIKI KAISHA, Tokyo (JP)

(21) Appl. No.: 13/152,545

(22) Filed: Jun. 3, 2011

(30) Foreign Application Priority Data
Jun. 4, 2010 (JP) 2010-129367

(51) Int. Cl. G06K 7/01

(52) U.S. Cl. 340/10.51

(57) ABSTRACT

An electronic device includes a reader-writer unit configured to read from and write to an RFID tag and a control unit. The control unit is configured to control the reader-writer unit to read a tag ID or a tag data of the RFID tag and configured to prevent or warn against a multiple-writing if it is determined that the tag data of the RFID tag has been previously subjected to writing based on the tag ID or the tag data of the RFID tag read by the reader-writer unit.

### CROSS-REFERENCE TO RELATED APPLICATIONS

This application is based upon and claims the benefit of priority from Japanese Patent Application No. 2010-129367, filed on Jun. 4, 2010, the entire contents of which are incorporated herein by reference.

### FIELD

Embodiments described herein relate generally to an electronic device for reading from and writing to RFID tag and a method for controlling the same.

### BACKGROUND

In recent years, there has been developed small wireless tags containing an IC chip and an antenna therein. By providing contactless communication with a dedicated reader-writer through the antenna, a wireless tag writes information to the memory of the IC chip or reads the information stored in the memory. In the manufacturing step, unique identification information called a tag ID, which is not rewritable, is initially stored in the wireless tag. The reader-writer recognizes individual media based on its tag ID and performs reading and writing of the information. Therefore, if the wireless tag is attached to an object to be recognized and if the information on the object is stored in the IC chip, a host connected to the reader-writer can identify the object having the wireless tag based on the tag information read by the reader-writer. This type of tag is often called an RFID (Radio Frequency Identification) tag and has been proposed for use in information management systems for logistics information management or personal information management.

In contrast to the conventional barcode system, using the RFID tag eliminates the need to use a reader-writer to scan each label on an item. Thus, it becomes possible to collectively read a plurality of item tags from a remote location and to collectively write to a plurality of item tags from a remote location.

However, when using UHF-band RFID tags over a long communication distance, it sometimes happens that, depending on the circumstances, data are erroneously written to tags other than the tag to which the tag data are intended to be written. Consequently, data may not be correctly written to the target tags, or data previously written into tags may be erroneously rewritten.

### BRIEF DESCRIPTION OF THE DRAWINGS

FIG. 1 is a view showing a configuration of major parts of a typical RFID tag.

FIG. 2 is a block diagram showing a configuration of major parts of an RFID tag reader-writer in one embodiment of an RFID device.

FIG. 3 is a view showing a schematic configuration of the entire system including an RFID tag, an RFID tag reader-writer, and a host.

FIG. 4 is a flowchart illustrating a first control process for writing data into an RFID tag.

FIG. 5 is a flowchart illustrating a second control method process for writing data into an RFID tag.

FIG. 6 is a flowchart illustrating a third control process for writing data into an RFID tag.

FIG. 7 is a flowchart illustrating a fourth control process for writing data into an RFID tag.

FIG. 8 is a flowchart illustrating a fifth control process for writing data into an RFID tag.

FIG. 9 is a flowchart illustrating a sixth control process for writing data into an RFID tag.

### DETAILED DESCRIPTION

According to one embodiment, an electronic device includes a reader-writer unit configured to read from and write to an RFID tag and a control unit. The control unit is configured to control the reader-writer unit to read a tag ID or a tag data of the RFID tag and configured to prevent or warn against a multiple-writing if it is determined that the tag data of the RFID tag has been previously subjected to writing based on the tag ID or the tag data of the RFID tag read by the reader-writer unit.

Embodiments will now be described in detail with reference to the drawings.

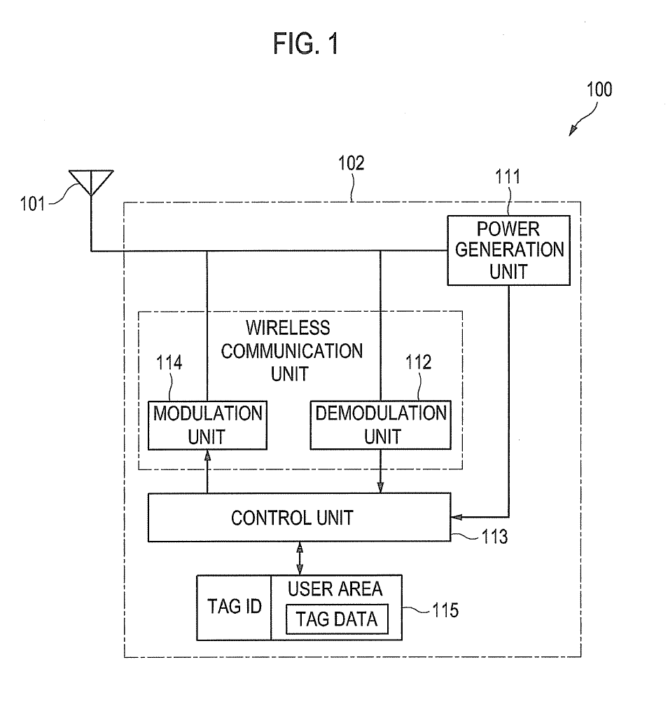

First, the configuration of an RFID tag will be described with reference to FIG. 1. FIG. 1 is a block diagram showing a configuration of major parts of an RFID tag. As shown in FIG. 1, an RFID tag 100 includes an antenna 101 and an IC chip 102. Although the antenna 101 is illustrated in FIG. 1 as being included in the RFID tag 100, the antenna 101 may be either built in the RFID tag 100 or attached externally to the RFID tag 100.

The IC chip 102 includes a power generation unit 111, a demodulation unit 112, a control unit 113, a modulation unit 114, and a non-volatile rewritable storage unit 115 such as a flash memory or an EEPROM. The power generation unit 111 supplies electric power to the respective units of the IC chip 102 by rectifying and stabilizing incoming modulation waves received by the antenna 101. The demodulation unit 112 demodulates the modulation waves and sends the demodulated waves to the control unit 113. The modulation unit 114 modulates the data from the control unit 113 and sends the modulated data to the antenna 101. The control unit 113 writes the demodulated data from the demodulation unit 112 into the storage unit 115 and reads the data from the storage unit 115 to send to the modulation unit 114. A tag ID, i.e. unique identification information assigned by a manufacturer during a manufacturing process of the RFID tag 100, may be initially stored in the storage unit 115. The storage unit 115 includes a user area into which arbitrary data (e.g., tag data) can be written by a user. Although the antenna 101 is shown as being attached on the outside of the IC chip 102 in the example of FIG. 1, it may be built into the IC chip 102 as a part of a wireless communication unit that includes the demodulation unit 112 and the modulation unit 114.

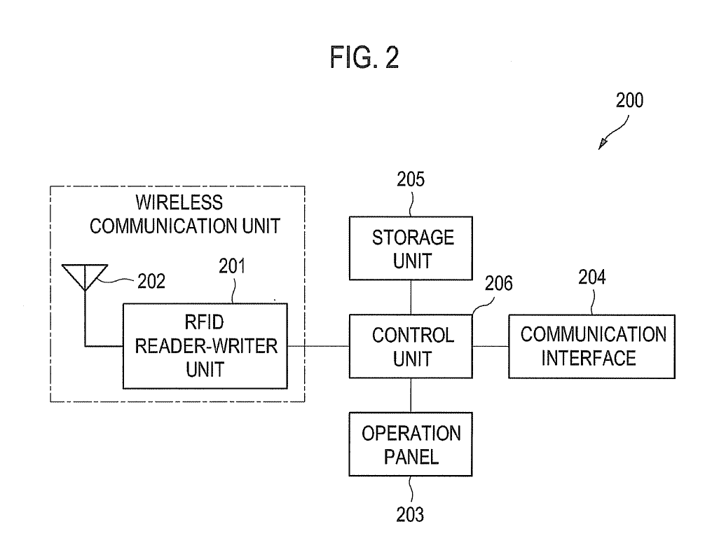

The configuration of an RFID tag reader-writer will be described with reference to FIG. 2. FIG. 2 is a block diagram showing the configuration of major parts of an RFID tag reader-writer 200 for reading or writing data from or into the RFID tag 100. As shown in FIG. 2, the RFID tag reader-writer 200 includes a wireless communication unit, which includes an RFID reader-writer unit 201 and an antenna unit 202, an operation panel 203, a communication interface 204, a storage unit 205, and a control unit 206.

The antenna unit 202 transmits modulation waves of read/write signals under the control of the RFID reader-writer unit 201 to the RFID tag 100. The antenna 202 also receives modulation waves from the RFID tag 100, which transmits the waves in response to receiving the modulation waves from RFID reader-writer unit 201. When reading from or writing to the RFID tag 100, the read/write signals are transmitted to the RFID tag 100, which is located within a communication area that the modulation waves transmitted from the antenna unit 202 can reach. Using the read/write signals, the RFID reader-writer unit 201 reads the data stored in the storage unit 115 of the RFID tag 100 and writes data into the storage unit 115 in a contactless manner.

The operation panel 203 provides various types of keys and a display unit. A variety of external devices are connected to the communication interface 204. A manager can operate the RFID tag reader-writer 200 through the use of the operation panel 203 or a host device (not shown) connected to the communication interface 204.

A control program for controlling the RFID tag reader-writer 200 and RFID writing data are stored in the storage unit 205. In this regard, the RFID writing data are information (tag data) to be written into the storage unit 115 of the RFID tag 100. The storage unit 205 may be a memory device such as a flash memory or an SRAM (Static Random Access Memory).

The control unit 206 is configured to control the RFID reader-writer unit 201, the operation panel 203, the communication interface 204, and the storage unit 205. Upon receiving an RFID issuance instruction from the host device (not shown) through the communication interface 204, the control unit 206 stores the RFID writing data included in the RFID issuance instruction in the storage unit 205.

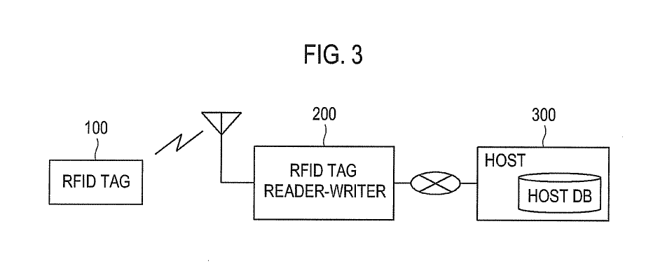

In one aspect of the present embodiment, the RFID tag reader-writer 200 reads necessary data from the RFID tag 100, into which data will be written as the target RFID tag. One or both of the tag ID and the tag data already stored in (or to be written to) the target RFID tag 100 are transmitted from the RFID tag reader-writer 200 to the external host (server). Then, a predetermined reply is transmitted if the tag ID or the tag data have been already registered in the database of the host (i.e., a host DB). If these data have actually been written or will be written, the data are registered in the host DB. In response to the reply, the RFID tag reader-writer 200 is configured to prevent or warn of a multiple-writing (the details of this control will be described below). FIG. 3 shows the schematic configuration of the entire system including the RFID tag 100, the RFID tag reader-writer 200, and the host 300. In another aspect, depending on whether the tag data has been already written or not, the RFID tag reader-writer 200 is controlled to prevent a multiple-writing, without resort to the external host 300 (the details of this control will be described below).

Next, description will be made on the summary of the operations performed between the RFID tag reader-writer 200 and the RFID tag 100.

When the RFID tag reader-writer 200 reads/writes data from/into the storage unit 115 of the RFID tag 100, communication control is executed between the RFID reader-writer unit 201 and the RFID tag 100 according to a standard (e.g., EPC™ Radio Frequency Identity Protocols Class-1 Generation-2 UHF RFID Protocol for communications at 860 MHz to 960 MHz).

When the RFID tag 100 receives read/write command data from the RFID reader-writer unit 201, the control unit 113 of the RFID tag 100 performs a specified process in response to the command data. When the RFID tag 100 completes the process, the RFID tag 100 sends the RFID reader-writer unit 201 an ACK (Acknowledgement) indicating that the command data from the RFID reader-writer unit 201 were received successfully (that the processing has been completed successfully). These basic operations are performed between the RFID tag reader-writer 200 and the RFID tag 100.

Next, control processes according to the present embodiment will now be described. In the flowcharts referred to below, the term “[RFID tag reader-writer]” indicates that the process is performed by the RFID tag reader-writer 200 while the term “[host]” indicates that the process is performed by the host 300.

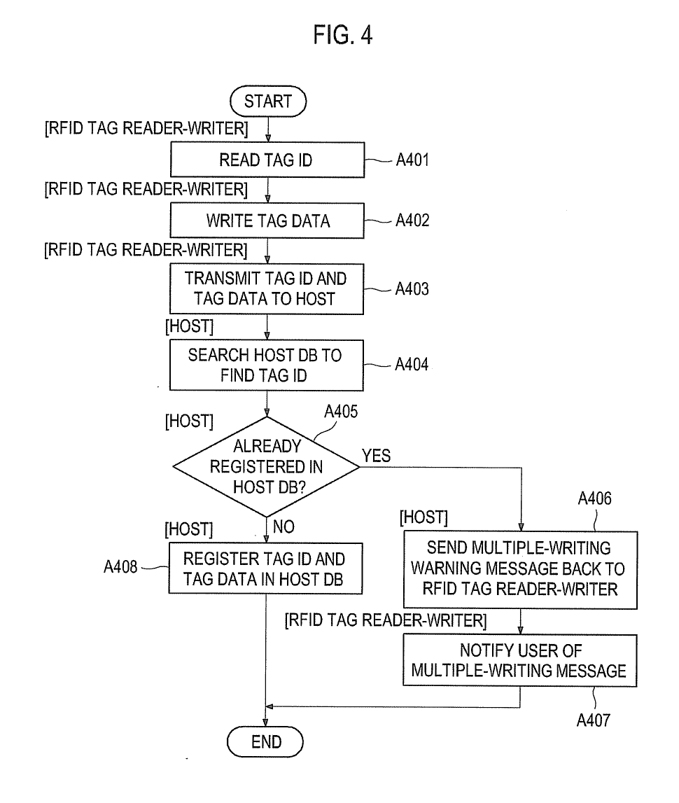

A first control process for writing data into the RFID tag will be first described with reference to FIG. 4.

When writing the tag data, the RFID tag reader-writer 200 first reads the tag ID from the RFID tag 100 (Act A401) and then writes the tag data (Act A402).

When the writing of the tag data is completed, the RFID tag reader-writer 200 transmits a set of the tag ID read in Act A401 and the written tag data to the host (Act A403).

When the tag ID is received from the RFID tag reader-writer 200, the host searches the host DB to find the same tag ID (Act A404). The host DB registers and manages tag IDs of RFID tags for the tag data that have already been written, together with the tag data.

Then, the host determines whether the tag ID received from the RFID tag reader-writer 200 has already been registered in the host DB (Act A405).

If the tag ID has been already registered in the host DB (i.e., if YES in Act A405), the host sends back to the RFID tag reader-writer 200 a multiple-writing warning message indicating that the multiple-writing has occurred (Act A406).

In response, the RFID tag reader-writer 200 displays information about the multiple-writing warning message on the operation panel 203 or generates a warning sound to notify the user of the multiple-writing warning message (Act A407). Alternatively, the multiple-writing warning message may be printed in the case where the RFID tag reader-writer 200 provides a printing function.

On the other hand, if the tag ID is not registered in the host DB (i.e., if NO in Act A405), the host registers the tag ID and the tag data in the host DB (Act A408).

The present control process then terminates. In the present control process, when writing the tag data into the RFID tag 100, it is determined whether the RFID tag was already subjected to writing based on the tag ID read from the RFID tag 100. If the RFID tag was already subjected to writing, the user may be notified of the warning message indicating that the multiple-writing has occurred. Although the host DB is described above as registering both the tag ID and the tag data, the present control process can be applied as long as the host DB registers at least the tag IDs.

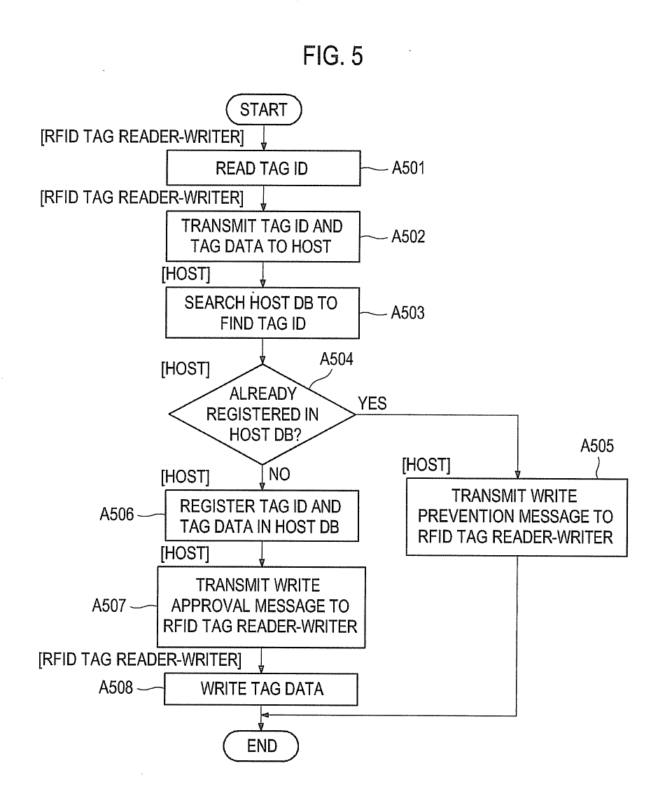

A second control process for writing data to the RFID tag will be described with reference to FIG. 5.

First, the RFID tag reader-writer 200 reads the tag ID from the RFID tag 100 (Act A501).

Then, the RFID tag reader-writer 200 transmits a set of the tag ID read in Act A501 and the tag data to be written to the host (Act A502).

When the tag ID is received from the RFID tag reader-writer 200, the host searches the host DB to find the same tag ID (Act A503). The host DB registers and manages tag IDs of RFID tags for the tag data that have already been written, together with the tag data.

Then, the host determines whether the tag ID received from the RFID tag reader-writer 200 has been already registered in the host DB (Act A504).

If the tag ID has been already registered in the host DB (i.e., if YES in Act A504), the host sends a write prevention message (e.g., do not write message) to the RFID tag reader-writer 200 (Act A505). Upon receiving the write prevention message, the RFID tag reader-writer 200 terminates the present control process without writing the tag data into the RFID tag 100.

On the other hand, if the tag ID is not registered in the host DB (i.e., if NO in Act A504), the host registers the tag ID and the tag data in the host DB (Act A506) and sends a write approval message back to the RFID tag reader-writer 200 (Act A507).

Upon receiving the write approval message from the host, the RFID tag reader-writer 200 writes the tag data into the target RFID tag (Act A508).

Thus, the present control process is terminated. In the present control process, writing the tag data is prevented if the target RFID tag 100 was already subjected to writing. If not, the tag data is written into the target RFID tag 100. Although the host DB is described above as registering both the tag ID and the tag data, the present control process can be applied as long as the host DB registers at least the tag IDs.

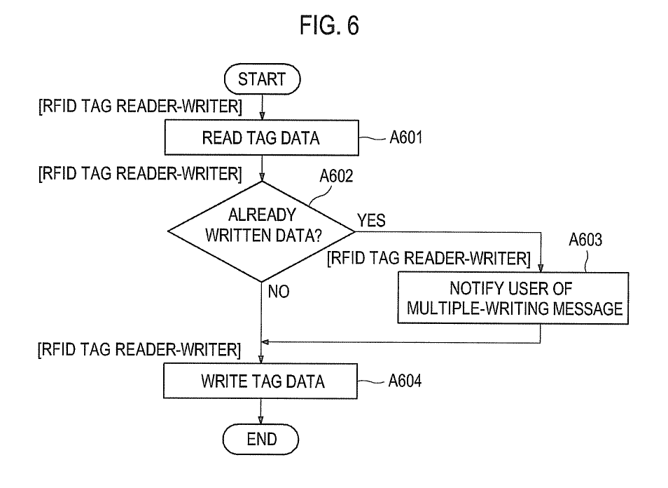

A third control process for writing data into the RFID tag will be described with reference to FIG. 6.

First, the RFID tag reader-writer 200 reads the tag data from the RFID tag 100 (Act A601).

Then, it is determined whether the tag data read from the RFID tag 100 indicate already written data (Act A602). For example, the tag data may be determined as being already written data if the tag data is not “0000.”

If the tag data read from the RFID tag 100 are the already written data (i.e., not “0000”) (i.e., if YES in Act A602), the RFID tag reader-writer 200 displays a multiple-writing warning message on the operation panel 203 indicating that a multiple-writing will occur or generates a warning sound to notify the user of the multiple-writing warning message (Act A603). Further, the multiple-writing warning message may be printed in the case where the RFID tag reader-writer 200 provides a printing function. Thereafter, the tag data is written into the target RFID tag 100 (Act A604).

On the other hand, if the tag data read from the RFID tag 100 is not the already written data (i.e., if NO in Act A602), the tag data is written into the target RFID tag 100 (Act A604).

The present control process then terminates. In the present control process, the RFID tag reader-writer 200 performs writing of the tag data if the RFID tag 100 has not yet been subjected to writing. In contrast, if the RFID tag 100 has been already subjected to writing, writing of the tag data is performed after notifying the user of the multiple-writing warning message.

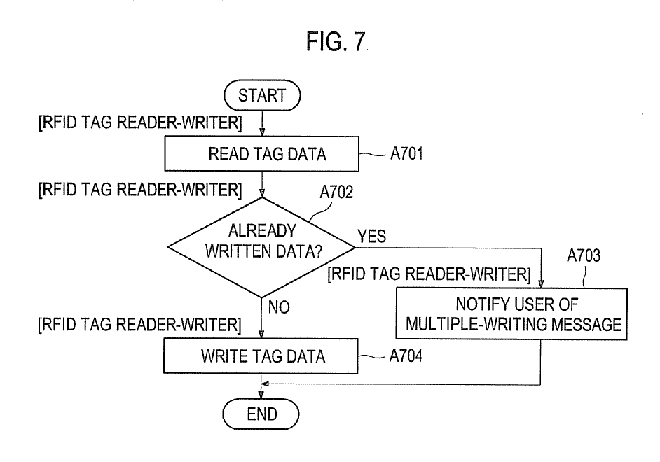

A fourth control process for writing data into the RFID tag will be described with reference to FIG. 7.

First, the RFID tag reader-writer 200 reads the tag data from the RFID tag 100 (Act A701).

Then, it is determined whether the tag data read from the RFID tag 100 indicate already written data (Act A702). For example, the tag data may be determined as being already written data if the tag data is not “0000.”

If the tag data read from the RFID tag 100 are the already written data (i.e., not “0000”) (i.e., if YES in Act A702), the RFID tag reader-writer 200 displays a multiple-writing warning message on the operation panel 203 indicating that a multiple-writing will occur or generates a warning sound to notify a user of the multiple-writing warning message (Act A703). Alternatively, the multiple-writing warning message may be printed in the case where the RFID tag reader-writer 200 provides a printing function.

On the other hand, if the tag data read from the RFID tag 100 is not the already written data (i.e., if NO in Act A702), the tag data is written into the target RFID tag 100 (Act A704).

Thus, the present control process is terminated. In the present control process, the RFID tag reader-writer 200 performs the writing of the tag data if the RFID tag 100 has not yet been subjected to writing. If the RFID tag 100 has been already subjected to writing, the multiple-writing warning message is provided to the user to prevent the tag data from being written into the RFID tag 100.

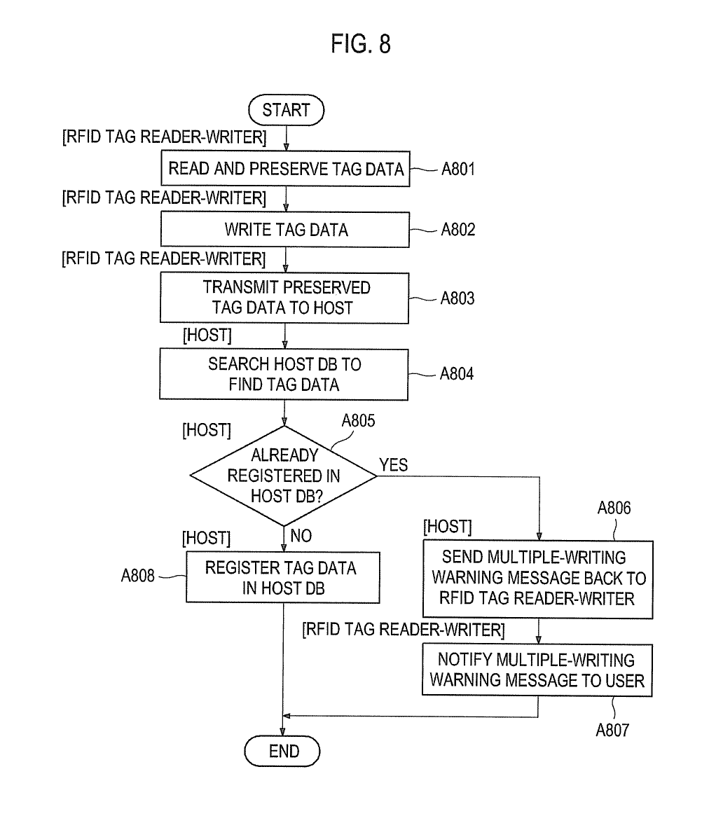

A fifth control process for writing data into the RFID tag will be described with reference to FIG. 8.

When writing the tag data, the RFID tag reader-writer 200 reads the tag data from the target RFID tag 100 to which writing will be performed and preserves the tag data (Act A801).

Then, the RFID tag reader-writer 200 writes the tag data to be written into the target RFID tag 100 (Act A802).

When the writing of the tag data is completed, the RFID tag reader-writer 200 transmits the tag data read and preserved in Act A801 to the host (Act A803).

When the tag data is received from the RFID tag reader-writer 200, the host searches the host DB to find the same tag data (Act A804). The tag data which were previously written are registered in the host DB.

Then, the host determines whether the tag data received from the RFID tag reader-writer 200 has already been registered in the host DB (Act A805).

If the tag data has already been registered in the host DB (i.e., if YES in Act A805), the host sends back to the RFID tag reader-writer 200 a multiple-writing warning message indicating that a multiple-writing has occurred (Act A806).

In response, the RFID tag reader-writer 200 displays a multiple-writing warning message on the operation panel 203 or generates a warning sound to notify the user of the multiple-writing warning message (Act A807). Alternatively, the multiple-writing warning message may be printed in the case where the RFID tag reader-writer 200 has a printing function.

On the other hand, if the tag data is not registered in the host DB (i.e., if NO in Act A805), the host registers the tag data in the host DB (Act A808).

Thus, the present control process is terminated. In the present control process, after writing the tag data first into the target RFID tag 100, it is determined whether the RFID tag was already subjected to writing based on the tag data read from the RFID tag 100. If the RFID tag was already subjected to writing, the user will be provided with the warning message indicating that a multiple-writing has occurred.

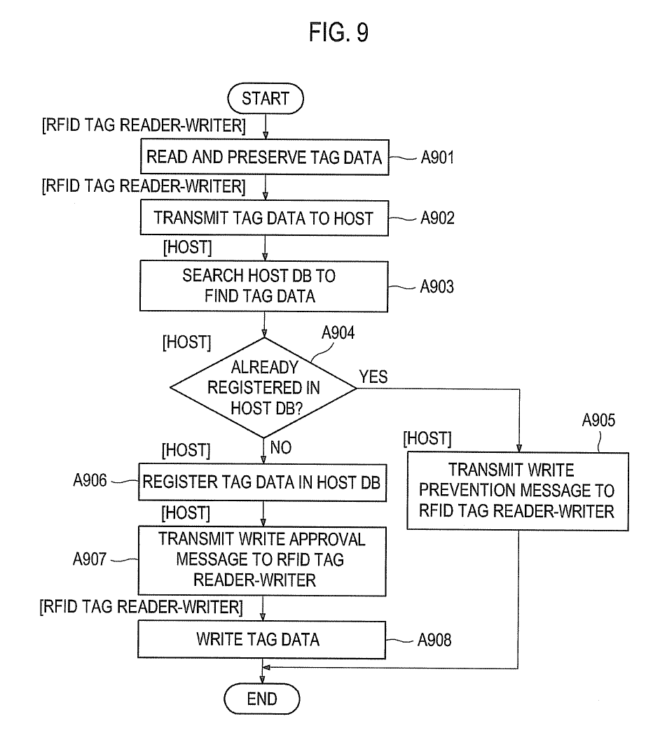

A sixth control process for writing data into the RFID tag will be described with reference to FIG. 9.

First, the RFID tag reader-writer 200 reads the tag data from the RFID tag 100 and preserves it (Act A901).

Then, the RFID tag reader-writer 200 transmits to the host the tag data read and preserved in Act A901 (Act A902).

When the tag data is received from the RFID tag reader-writer 200, the host searches the host DB to find the same tag data (Act A903). The tag data which were previously written are registered in the host DB.

Then, the host determines whether the tag data received from the RFID tag reader-writer 200 has already been registered in the host DB (Act A904).

If the tag data has been already registered in the host DB (i.e., if YES in Act A904), the host sends a write prevention message back to the RFID tag reader-writer 200 (Act A905). Upon receiving the write prevention message, the RFID tag reader-writer 200 terminates the present control process without writing the tag data into the RFID tag 100.

On the other hand, if the tag data was not registered in the host DB (i.e., if NO in Act A904), the host registers the tag data in the host DB (Act A906) and send a write approval message back to the RFID tag reader-writer 200 (Act A907).

Upon receiving the write approval message from the host, the RFID tag reader-writer 200 writes the tag data into the target RFID tag (Act A908).

Thus, the present control process is terminated. In the present control process, before writing the target data into the RFID tag 100, it is determined whether the RFID tag 100 was already subjected to writing based on the tag data read from the RFID tag 100. If the target RFID tag 100 was already subjected to writing, writing the tag data is prevented and the tag data are not written. If not, the tag data is written into the RFID tag 100.

In the control processes described above, it is preferable to employ a configuration in which a user configuration unit, such as the operation panel 203 of the RFID tag reader-writer 200 or a switch (not shown), is used to select whether to issue the multiple-writing warning message after writing the tag data or to initially prevent the writing of the tag data in case of occurrence of a multiple-writing.

According to the embodiments described above, it is determined whether the tag data has been already written into the RFID tag 100 based on the individual tag ID or tag data read from the RFID tag 100. A multiple-writing warning message is provided to the user in the event that the writing is performed into the RFID tag into which the tag data has been previously written. Alternatively, the tag data writing may not be performed if the tag data has been previously written. Accordingly, it is possible to prevent occurrence of a multiple-writing or erroneous writing.

The processes performed by the RFID tag reader-writer 200, which are illustrated in FIGS. 4 through 9, may be incorporated in a non-volatile memory such as the flash memory of the storage unit 205 in the form of a control program executed by the control unit 206 of the RFID tag reader-writer 200. Alternatively, the control program may be provided as being recorded in a computer-readable recording medium such as a CD-ROM, a flexible disk (FD), a CD-R, a DVD (Digital Versatile Disk) or a removable memory in the form of an installable or executable file. Then, the RFID tag reader-writer 200 may install the control program in the storage unit 205 of the RFID tag reader-writer 200 through the host. The control program may be also stored in a computer connected to a network such as the Internet so that the RFID tag reader-writer 200 can download the control program from the computer via the network and the host and install the same in the storage unit 205.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the processes can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a reader-writer unit configured to read from and write to an RFID tag; and
a control unit configured to control the reader-writer unit to read a tag ID or a tag data of the RFID tag and configured to prevent or warn against a multiple-writing if it is determined that the tag data of the RFID tag has been previously subjected to writing based on the tag ID or the tag data of the RFID tag read by the reader-writer unit.

2. The electronic device of claim 1, further comprising: a communication interface configured to communicate with a host device having a database of tag IDs including the tag ID of the RFID tag to which the tag data has been previously written,
wherein the reader-writer unit is configured to read the tag ID of the RFID tag, the communication interface is configured to transmit the tag ID read by the reader-writer unit to the host device, and the control unit is further configured to prevent writing of the tag data to the RFID tag or warn against the multiple-writing if a reply from the host device, responsive to the tag ID transmitted by the communication interface, indicates that the tag data of the RFID tag has been already subjected to writing.

3. The electronic device of claim 1, further comprising: a communication interface configured to communicate with a host device having a database of tag IDs including the tag data of the RFID tag to which the tag data has been previously written,
wherein the reader-writer unit is configured to read the tag data of the RFID tag, the communication interface is configured to transmit the tag data read by the reader-writer unit to the host device, and the control unit is further configured to prevent writing of the tag data to the RFID tag or warn against the multiple-writing if a reply from the host device, responsive to the tag data transmitted by the communication interface, indicates that the tag data of the RFID tag has been already subjected to writing.

4. The electronic device of claim 2, wherein the reader-writer unit is configured to write the tag data to the RFID tag and provide a warning of the multiple-writing if the reply from the host device, indicating that the tag data of the RFID tag has been previously subjected to writing, is received.

5. The electronic device of claim 2, wherein the control unit is configured to prevent writing of the tag data to the RFID tag if the reply from the host device indicates that the tag data of the RFID tag has been previously subjected to writing, and configured to allow the reader-writer unit to write the tag data to the RFID tag if the reply from the host device indicates that the tag data of the RFID tag has not previously subjected to writing.

6. The electronic device of claim 3, wherein the reader-writer unit is configured to write the tag data to the RFID tag and provide a warning of the multiple-writing if the reply from the host device, indicating that the tag data of the RFID tag has been previously subjected to writing, is received.

7. The electronic device of claim 3, wherein the control unit is configured to prevent writing of the tag data to the RFID tag if the reply from the host device indicates that the tag data of the RFID tag has been previously subjected to writing, and configured to allow the reader-writer unit to write the tag data to the RFID tag if the reply from the host device indicates that the tag data of the RFID tag has not previously subjected to writing.

8. The electronic device of claim 1, further comprising:
a storage unit configured to store the tag ID or the tag data of the RFID tag; and
an operation panel configured to warn against the multiple-writing.

9. A method for controlling an electronic device having a reader-writer unit configured to read from and write to an RFID tag, comprising:
reading, by the reader-writer unit, a tag ID or a tag data of an RFID tag;
determining whether the tag data of the RFID tag has been previously subjected to writing based on the tag ID or the tag data of the RFID; and
if it is determined that the tag data of the RFID tag has been previously subjected to writing, preventing writing of the tag data to the RFID tag or warning against a multiple-writing.

10. The method of claim 9, further comprising:
writing the tag data to the RFID tag regardless of whether the tag data of the RFID tag has been previously subjected to writing; and
if it is determined that the tag data of the RFID tag has been previously subjected to writing, providing a warning of the multiple-writing.

11. The method of claim 10, further comprising:
before writing the tag data to the RFID tag, storing the tag data previously stored in the RFID tag to a storage unit of the electronic device.

12. The method of claim 9, further comprising:
if it is determined that the tag data of the RFID tag has been previously subjected to writing, preventing the tag data from being written to the RFID tag and providing a message that the tag data is not written to the RFID tag; and
if it is determined that the tag data of the RFID tag has not been previously subjected to writing, writing the tag data to the RFID tag.

13. The method of claim 9, wherein determining whether the tag data of the RFID tag has been previously subjected to writing comprises:
searching a database of tag IDs in a host device for the tag ID of the RFID tag.

14. The method of claim 9, wherein determining whether the tag data of the RFID tag has been previously subjected to writing comprises:
searching a database of tag data in a host device for the tag data of the RFID tag.

15. A method for controlling an electronic device, having a reader-writer unit configured to read from and write to an RFID tag, comprising:
reading, by the reader-writer unit, a tag information from an RFID tag;
determining whether the RFID tag has been previously written based on the tag information of the RFID; and
if it is determined that the RFID tag has been previously written, providing a warning of previous writing to the RFID tag.

16. The method of claim 15, further comprising:
if it is determined that the RFID tag has been previously written, preventing the tag information from being written to the RFID tag.

17. The method of claim 15, wherein the tag information includes a tag ID and a tag data, and wherein the determination of if the RFID tag has been previously written is based on the tag data.

18. The method of claim 15, wherein determining whether the RFID tag has been previously written comprises:
providing the tag information to a host device; and
determining whether the tag information is registered in a database of the host device.

19. The method of claim 18, wherein determining whether the RFID tag has been previously written further comprises:
if the tag information is not registered in the database of the host device, registering the tag information in the database of the host device.

20. The method of claim 15, further comprising:
writing the tag information to the RFID tag.
